(19) United States
(12) Patent Application Publication
(10) Pub. No.: US 2016/0047342 A1
(43) Pub. Date: Feb. 18, 2016

(54) Centrifugal separator and filter arrangement

(71) Applicant: MANN+HUMMEL GMBH, Ludwigsburg (DE)

(72) Inventors: Michael Kraxner, Landeck (AT); Volker Greif, Harthausen (DE); Thomas Grein, Eggenstein-Leopoldshafen (DE); Dennis Stark, Mauer (DE)

(21) Appl. No.: 14/823,323

(22) Filed: Aug. 11, 2015

(30) Foreign Application Priority Data
Aug. 12, 2014 (DE) 10 2014 011 784.7

(51) Int. Cl. F02M 35/022; F02M 35/02; B01D 45/16

(52) U.S. Cl. CPC F02M 35/0223; B01D 45/16; F02M 35/0201

(57) ABSTRACT

A centrifugal separator (1) for separating particles (2) from a fluid, having a guide apparatus (8) that has a housing (12) with an inflow opening (4) and an outflow opening (14), a core (18) accommodated in said housing (12) and guide blades (26) that are arranged between the core (18) and the housing (12), wherein the cross-sectional area (A) of the guide apparatus (8), through which the fluid flows through the guide apparatus (8), changes starting from the inflow opening (4) towards the outflow opening (14) in a flow direction (6) of the guide apparatus (8).

### TECHNICAL FIELD

The present invention relates to a centrifugal separator and a filter arrangement, for example for filtering combustion air for an internal combustion engine.

### Background

A centrifugal separators, also referred to as cyclone or cyclone separator, serves for separating solid or liquid particles contained in fluids, in particular in gases. A fluid flowing into a centrifugal separator is guided such that centrifugal forces accelerate the particles to be separated from the fluid, whereby the particles are separated from the fluid. For generating the centrifugal forces, in most cases, guide blades are used that generate a swirl flow within the housing of the centrifugal separator.

Centrifugal separators can be used, for example, as aft filters for combustion air of internal combustion engines. In particular in the case of heavily dust-laden environments in which in particular agricultural or construction machinery is used, centrifugal separators have proven to be suitable.

In order to increase the degree of separation of dirt particles from air or fluid, multi-stage filter arrangements have also been proposed in the past. After a pre-separation by means of a centrifugal separator, a further purifying filtering action using conventional filter media can be carried out, for example. However, this is associated with increased manufacturing expenditure and additional limitations with regard to the installation situation of a corresponding filter arrangement. In this respect, it is desirable to improve the filtering capacity of centrifugal separators, in particular when used as an aft filter for internal combustion engines.

### SUMMARY OF THE INVENTION

It is therefore an object of the present invention to provide an improved centrifugal separator.

Accordingly, a centrifugal separator for separating particles from a fluid is proposed. The centrifugal separator comprises a guide apparatus that has a housing with an inflow opening and an outflow opening, a core accommodated in the housing and guide blades that are arranged between the core and the housing, wherein a cross-sectional area of the guide apparatus, through which the fluid flows through the guide apparatus, changes starting from the inflow opening towards the outflow opening in a flow direction of the guide apparatus.

Due to the fact that the cross-sectional area of the guide apparatus changes in the flow direction, the velocity at which the fluid flows through the centrifugal separator can be influenced, in particular increased so as to improve the degree of separation. The cross-sectional area is in particular positioned perpendicular to a center- or symmetry axis of the housing of the guide apparatus. The cross-sectional area is preferably defined as a region between the core, in particular an outer diameter of the core, and a housing wall, in particular an inner diameter of the housing of the guide apparatus.

The centrifugal separator can also be designated as axial centrifugal separator or axial cyclone separator. This means, the inflow direction into the centrifugal separator is from the front and not tangentially from the side. Such separators are also designated as inline cyclones.

The centrifugal separator is in particular suitable for motor vehicles, rail vehicles, aircrafts, watercrafts, for building technology, for track vehicles and caterpillars or the like.

“Flow direction” is to be understood as the direction in which the fluid, in particular a gas such as air, flows into the centrifugal separator or the guide apparatus. The flow direction is oriented along a center axis of a housing of the centrifugal separator.

The housing of the guide apparatus can be designated as guide apparatus housing. The housing of the centrifugal separator preferably comprises two sections, namely the guide apparatus housing and a further or second housing section. The guide apparatus housing and the second housing section can be adhesively bonded to one another, screwed together, snapped together or otherwise fixedly connected to one another. In particular, the guide apparatus housing and the second housing section can be separated from one another. As an alternative, the guide apparatus housing and the second housing section can be formed in one piece. The guide apparatus is preferably tubular and comprises a circular cross-section. The guide apparatus housing and/or second housing section are/is preferably provided with a constant inner cross-section, in particular with a constant inner diameter. This means that the preferred inner shape of these housings is a cylindrical tube shape. In particular, the core, which can also be designated as hub, is positioned centrally in the guide apparatus housing. The guide blades or guide elements connect the core to the guide apparatus housing.

In embodiments, the cross-sectional area is defined by an annular geometry which is delimited by an outer surface of the core and an inner surface of the housing. The outer surface of the core and/or the inner surface of the housing can be cylindrically. In particular, the outer surface of the core and/or the inner surface of the housing can be conically.

In embodiments, the housing, the core and the guide blades are formed integrally from the same material. In particular, the guide apparatus is a single-material integral plastic injection molded component. As a result of this, the guide apparatus can be produced cost-effectively in high quantities.

In embodiments, the cross-sectional area decreases in the flow direction. Through this, the velocity at which the fluid flows through the centrifugal separator and in particular through the guide apparatus can be increased. Hereby, the degree of separation increases.

In embodiments, the core comprises a cavity that has an opening that is directed in the direction of the outflow opening. The cavity is preferably provided in the form of a blind hole extending from a front side of the core towards a tip of the core. Hereby, savings in material and weight reduction can be achieved; furthermore, manufacturability when using the injection molding method is ensured even in the case of larger diameters. The blind hole can be provided with a draft angle. The tip is preferably hemispherical or curved. The tip is preferably fluid-tight. This results in a better inflow behavior, improved aerodynamics and reduced flow resistance. The tip can extend beyond the leading edges of the guide blades. In particular, the tip can extend beyond an outer edge of the inflow opening of the guide apparatus. This means, the tip can extend counter to the flow direction and/or an inflow direction.

In embodiments, a respective trailing edge of the guide blades can be formed to be flush with an end face of the core. The guide blades are preferably positioned to be flush with an outer edge of the outflow opening of the guide apparatus.

In embodiments, the core widens in the flow direction. Through this, the cross-section of the guide apparatus is reduced in the flow direction. The housing of the guide apparatus can have a circular cross-section with a constant cross-sectional area.

In embodiments, the core is conical at least in sections, wherein a cone angle of the core is preferably 3°. “Cone angle” is to be understood as the angle between the center axis of the housing and the outer surface of the core. The cone angle is preferably 0.5° to 5°, more preferably 1° to 4°, more preferably 2° to 3°, more preferably exactly 3°.

In embodiments, the housing narrows in the flow direction. The housing narrows optionally or additionally to the conical geometry of the core. Preferably, the housing is formed conically at least in sections.

In a preferred embodiment, the guide apparatus has at least one guide blade that extends over more than a full helical winding. For example, this can improve the centrifugal acceleration in interaction with the changing cross-section.

In a preferred embodiment, the guide blades exhibit a multiple overlapping, in particular at least a 2-, 3-, 4- or 5-fold overlapping. This facilitates the formation of a uniform flow; furthermore, the centripetal acceleration in interaction with the changing cross-section can also be improved in this manner.

Furthermore, a filter arrangement is proposed. The filter arrangement comprises at least one such centrifugal separator and a holding device for holding the at least one centrifugal separator. The holding device can be formed as a holding plate. Preferably, the holding device is fluid-tight. In particular, the filter arrangement has a plurality of centrifugal separators. The centrifugal separators can be connected in parallel.

Further possible implementations of the centrifugal separator and/or the filter device also comprise combinations, which are not explicitly mentioned, of features or embodiments of the centrifugal separator and/or the filter device described above or in the following with respect to the exemplary embodiments. In this context, the person skilled in the art will also add individual aspects as improvements or supplements to the respective basic version of the centrifugal separator and/or filter device.

Further configurations of the centrifugal separator and/or filter device are subject matter of the sub-claims and the exemplary embodiments of the centrifugal separator and/or filter device described below. Furthermore, the centrifugal separator and/or the filter device are/is explained in greater detail based on exemplary embodiments with reference to the attached figures.

### BRIEF DESCRIPTION OF THE DRAWINGS

In the figures:

FIG. 1 shows a schematic sectional view of an embodiment of a centrifugal separator;

FIG. 2 shows a schematic sectional view of the centrifugal separator according to the section line A-A of FIG. 1;

FIG. 3 shows a schematic top view of another embodiment of a centrifugal separator;

FIG. 4 shows a schematic sectional view of the centrifugal separator according to the section line A-A of FIG. 3;

FIG. 5 shows another schematic sectional view of the centrifugal separator according to the section line B-B of FIG. 4;

FIG. 6 shows a schematic top view of an embodiment of a filter arrangement;

FIG. 7 shows a schematic sectional view of the filter arrangement according to the section line A-A of FIG. 6; and

FIG. 8 shows another schematic sectional view of the filter arrangement according to the section line B-B of FIG. 6

In the figures, the same reference numbers designate identical or functionally identical elements unless otherwise stated.

### DETAILED DESCRIPTION OF THE INVENTION

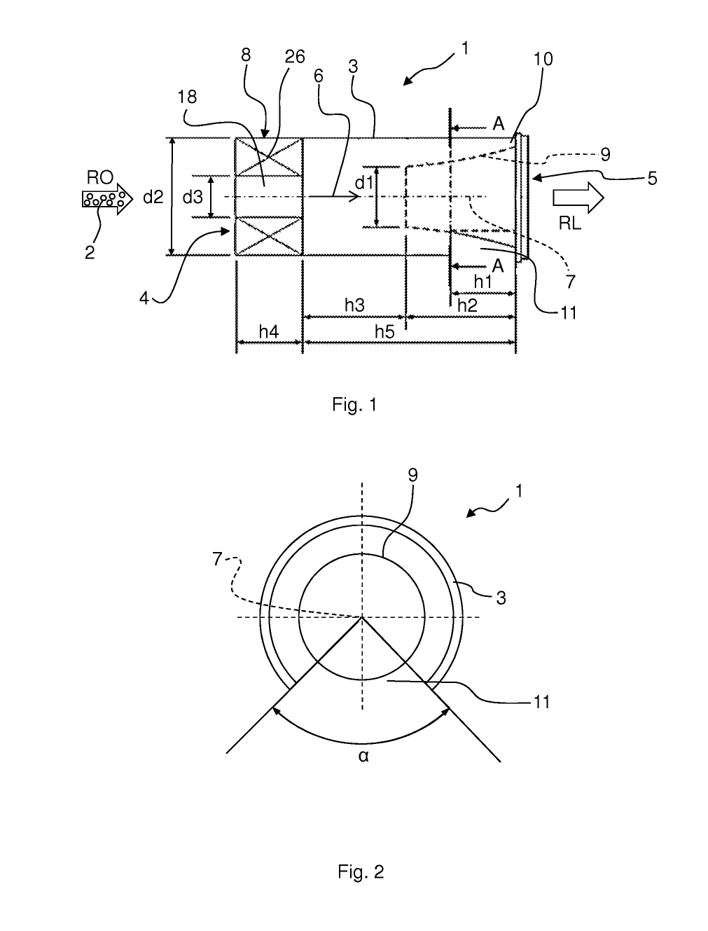

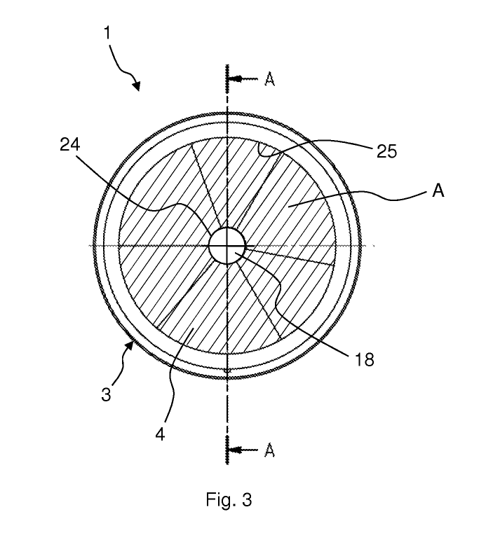

FIG. 1 shows a schematic sectional view of an embodiment of a cyclone separator or a centrifugal separator 1. The centrifugal separator 1 is an axial cyclone separator or axial centrifugal separator. In the case of the axial cyclone separator or axial cyclone, the inflow direction into the axial cyclone separator is from the front and not tangentially from the side. FIG. 2 shows another schematic sectional view of the centrifugal separator 1 according to the section line A-A of FIG. 1. Below, reference to FIGS. 1 and 2 is made at the same time.

The centrifugal separator 1 is in particular suitable for motor vehicles, rail vehicles, aircrafts, watercrafts, for budding technology, for track vehicles and caterpillars or the like.

A fluid laden with particles 2 is cleaned of the particles 2 by means of the centrifugal separator 1. The fluid is a gas such as air, for example. The particles 2 can be solids such as dust, sand or liquid droplets. A crude fluid RO laden with particles 2 and flowing into the centrifugal separator 1 is indicated in FIG. 1 in the form of an arrow. After passing through the centrifugal separator 1, cleaned air or pure fluid RL flows out of the centrifugal separator 1. The particles 2 are separated from the crude fluid RO and fed laterally out of the centrifugal separator 1. The centrifugal separator 1 has a tubular housing 3 with an inflow opening 4 and an outflow opening 5. A flow direction 6 of the centrifugal separator 1 is oriented from the inflow opening 4 towards the outflow opening 5. The housing 3 has a longitudinal, symmetry or center axis 7.

Furthermore, the centrifugal separator 1 has a guide apparatus 8, which is indicated only schematically in FIG. 1. The guide apparatus 8 is adapted to accelerate the crude fluid RO laden with particles 2 in such a manner that the particles 2 are separated from the crude fluid RO, and the particles 2 can be discharged separately from the pure fluid RL out of the housing 3.

The guide apparatus 8 has a housing, which is not shown, a core 18 arranged in the housing and guide blades or guide elements 26 which are arranged between the core 18 and the housing. The housing of the guide apparatus 8 can be formed integrally with the housing 3 of the centrifugal separator 1.

The centrifugal separator 1 comprises an immersion tube 9 that protrudes from the outflow opening 5 in the direction of the inflow opening 4 into the housing 3. The immersion tube 9 can have a conical geometry. The immersion tube 9 has minimum immersion tube diameter d1. The immersion tube diameter d1 is positioned at the immersion tube 9 with its end facing towards the inflow opening 4. The housing of the guide apparatus 8 has a housing diameter d2 which is larger than the immersion tube diameter d1. The core 18 has a core diameter d3. The core diameter d3 is preferably smaller than the immersion tube diameter d1.

A particle discharge window or a particle discharge opening 11 is provided at an end section 10 of the housing 3 facing away from the guide apparatus 8. The particle discharge opening 11 has a depth h1 and encloses an angular sector a about the center axis 7. The particles 2 can be discharged through the particle discharge opening 11. Due to the force of gravity, the particles 2 fall out of the centrifugal separator 1 or can also be actively sucked off.

The immersion tube 9 protrudes from the outflow opening 5 with an immersion tube depth h2 into the housing 3. A front edge of the immersion tube 9 is spaced apart from the guide apparatus 8 by a distance h3. The guide apparatus 8 has a height h4. The height h4 of the guide apparatus 8 is to be understood in relation to the center axis 7 as a section in which the guide blades run around the core. One could also speak of a length of the guide apparatus 8. The guide apparatus 8 is arranged spaced apart from the outflow opening 5 by a distance h5.

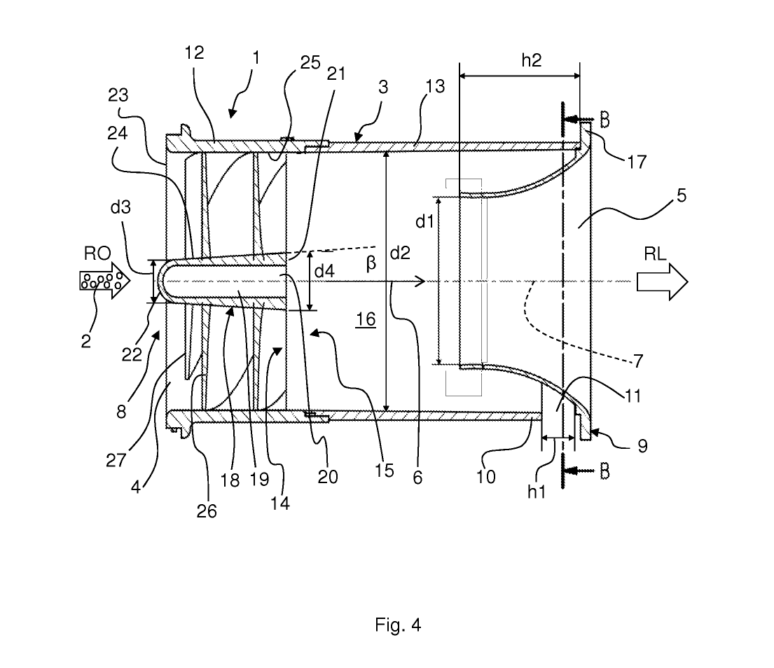

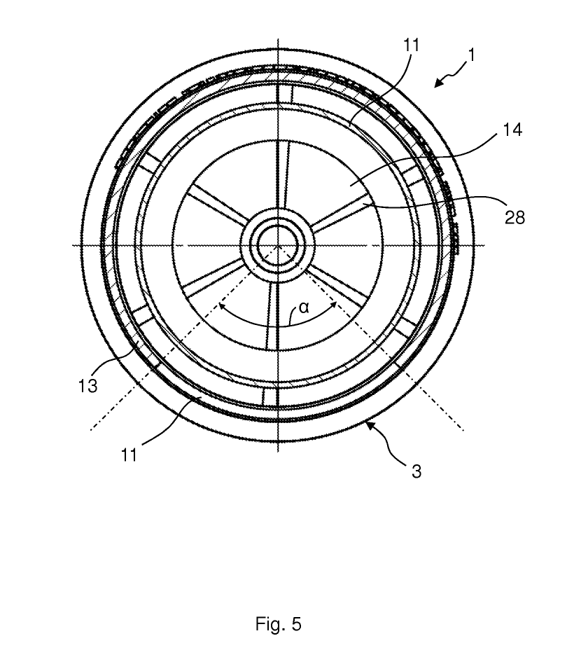

FIG. 3 shows a schematic front view of another embodiment of a centrifugal separator 1. FIG. 4 shows a schematic cross-sectional view of the centrifugal separator 1 according to the section line A-A of FIG. 3. FIG. 5 shows another schematic sectional view of the centrifugal separator 1 according to the section line B-B of FIG. 4. Below, reference to FIGS. 3 to 5 is made at the same time.

The centrifugal separator 1 has the tubular housing 3 with the inflow opening 4 and the outflow opening 5. The housing 3 can be formed in two pieces. However, the housing 3 is preferably formed integrally from a single material. The housing 3 of the centrifugal separator 1 comprises a first housing section or a guide apparatus housing or housing 12 of the guide apparatus 8. The housing 3 further comprises a second housing section 13. The housing sections 12, 13 can be clipped, welded or adhesively bonded together or otherwise fixedly connected to one another. The guide apparatus housing 12 has an inflow opening 4 and an outflow opening 14. The immersion tube 9, which has an outflow opening 5, protrudes into the second housing section 13.

The guide apparatus 8 comprises the guide apparatus housing 12 or vice versa. The inner housing diameter d2 of the guide apparatus housing 12 and of the second housing section 13 ranges between 10 to 100 millimeters, for example. The immersion tube 9 is provided at the end section 10 of the second housing section 13 that faces away from the guide apparatus 8. The immersion tube 9 can be formed conically or, as shown in FIG. 4, can be a rotation body having a curved geometry that narrows towards the guide apparatus 8. The immersion tube 9 protrudes into an interior 16 of the housing 3, in particular of the second housing section 13. The immersion tube 9, for example, is integrally connected to an immersion tube plate 17 by means of adhesive bonding, clamping, snap fitting or the like, which immersion tube plate fixes the immersion tube 9 in the position thereof in the interior 16 of the housing 3. The immersion tube 9 protrudes from the outflow opening 5 or from the immersion tube plate 17 with the immersion tube depth h2 towards the guide apparatus 8. The immersion tube 9 and the housing 3 are formed as two pieces. As an alternative, the immersion tube 9 and the housing 3 can also be formed as one piece.

Furthermore, the particle discharge opening 11 is provided at the end section 10 of the housing 3, in particular at the end section 10 of the second housing section 13. The particles 2 separated from the crude air RO are discharged radially with respect to the center axis 7 of the housing 3 through the particle discharge opening 11. The particle discharge opening 11 has the depth h1 and the angular sector α.

The guide apparatus 8 has a hub and a core 18. The core 18 is formed to be rotationally symmetric to the center axis 7. The core 18 comprises a cavity 19 that has an opening 20 that is directed towards the outflow opening 5 and/or 14. The cavity 19 is in particular a blind bore extending in the direction of the inflow opening 4. The opening 20 is provided at an end face 21 of a first end section of the core 18.

The core 18 has a tip 22 that faces away from the outflow opening 14. The tip 22 is preferably fluid-tight. The tip 22 can in particular be dome-shaped or spherical and can be formed integrally with the core 18 and from the same material. The cavity 19 preferably extends into the tip 22. The tip 22 can be formed to be flush with an outer edge 23 of the inflow opening 4. As an alternative, the tip 22 can protrude beyond the outer edge 23, as shown in FIG. 4.

The core 18 is preferably conically shaped and has an outer surface 24. As shown in FIG. 4, the outer surface 24 is inclined at a cone angle β to the center axis 7. The cone angle β is to be understood as an angle between the center axis 7 and the outer surface 24. The angle β is preferably 0.5° to 5°, more preferably 1° to 4°, more preferably 2° to 3°, more preferably exactly 3°. This means, the core 18 widens its cross-section in the direction of the flow direction 6. At the end section facing away from the tip 22, the core 18 has a diameter d4. The diameter d4 is larger than the diameter d3 of the tip 22. In addition to the change in cross-section of the area through which the flow passes, removing the guide apparatus 8 as an injection molded part from the corresponding tool is facilitated if the cone angle is greater than 0.5°.

A cross-sectional area A of the guide apparatus 8 of the centrifugal separator 1, shown in FIG. 3, has an annular geometry that is delimited by the outer surface 24 of the core 18 and an inner surface 25 of the housing 12 of the guide apparatus 8. The cross-sectional area A changes in the flow direction 6 since the core 18 is conical. In particular, starting from the inflow opening 4, the cross-sectional area A is reduced or becomes smaller in the flow direction 6 towards the outflow opening 14 of the guide apparatus 8.

In an alternative embodiment of the centrifugal separator 1, which is not shown, the core 18 can have an unchanging cross-section. In this embodiment of the centrifugal separator 1, a cross-section of the housing 12 of the guide apparatus 8 narrows starting from the inflow opening 4 in the direction of the outflow opening 14. In addition, the core 18 can have a conical shape, as shown in FIG. 4.

In addition to the core 18, the guide apparatus 8 comprises guide elements or guide blades 26. The number of guide blades 26 is arbitrary. As shown in FIGS. 3 to 5, the guide apparatus 8 can comprise six guide blades 26. Each guide blade 26 has a leading edge 27 (FIG. 4) and a trailing edge 28 (FIG. 5). The leading edge 27 is oriented in the direction of the inflow opening 4. The trailing edge 28 is oriented in the direction of the outflow opening 14 and/or 5. The trailing edge 28 of each guide blade 26 is preferably formed to be flush with the end face 21 of the core 18. The leading edges 27 are preferably placed backwards behind the outer edge 23 of the inflow opening 4. The guide blades 26 preferably exhibit a multiple overlapping, for example at least a 2-, 3-, 4- or 5-fold overlapping. This means, there is no gap between the guide blades 26 in the flow direction 6. In particular, three guide blades 26 are arranged in each case one above the other. Each of the guide blades 26 runs between an inner spiral line or helix provided on the core 18 and an outer helix provided on the inner surface 25 of the housing 12 of the guide apparatus 8. Each of the guide blades 26 runs helically around the core 18.

The guide apparatus housing 12, the core 18 and the guide blades 26 are preferably formed integrally from the same material. In particular, the guide apparatus 8 is a one-piece plastic injection molded component.

Due to the fact that the cross-section A of the guide apparatus 8 decreases in the flow direction 6 from the inflow opening 4 towards the outflow opening 14 and/or 5, the crude fluid RO to be cleaned is accelerated when flowing through the centrifugal separator 1, resulting in a higher degree of separation of particles 2.

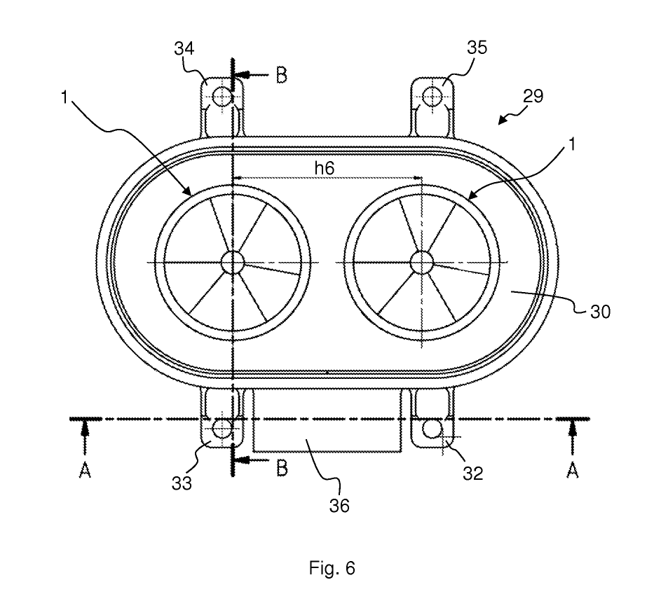

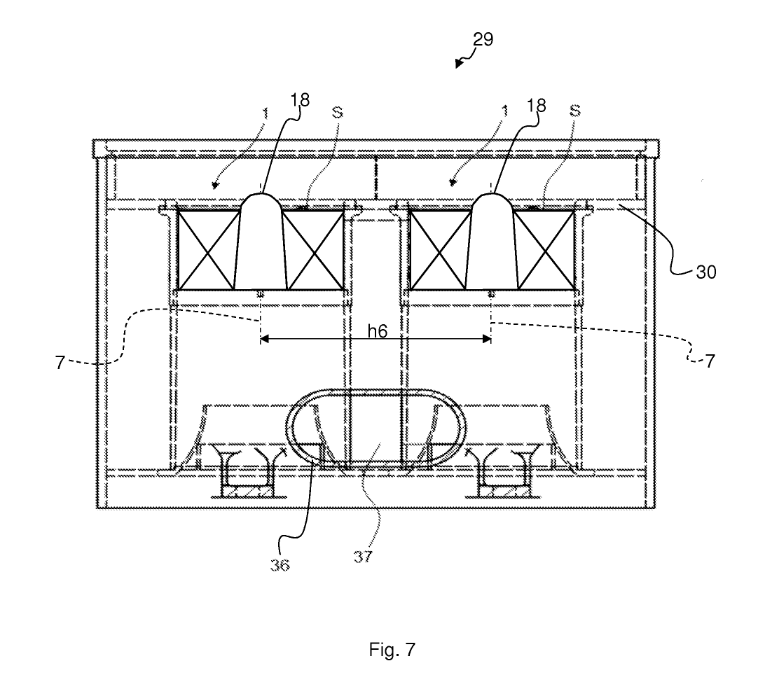

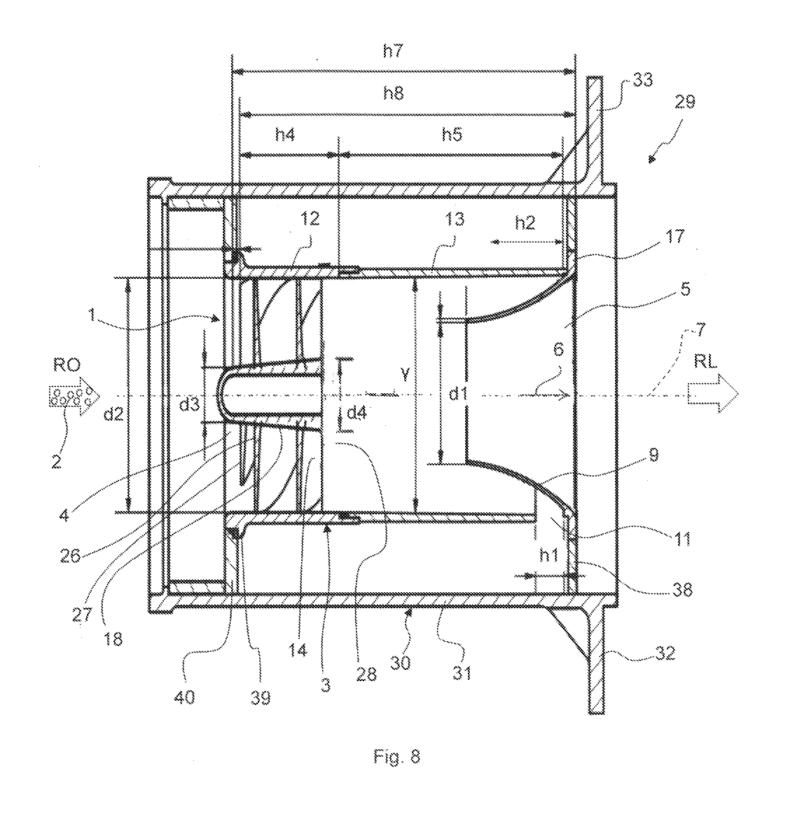

FIG. 6 shows a schematic top view of an embodiment of a filter arrangement 29. FIG. 7 shows a schematic sectional view of the filter arrangement 29 according to the section line A-A of FIG. 6. FIG. 8 shows another schematic sectional view of the filter arrangement 29 according to the section line B-B of FIG. 6. Below, reference to FIGS. 6 to 8 is made at the same time.

The filter arrangement 29 has at least one, but preferably a plurality of centrifugal separators 1. The number of centrifugal separators 1 is arbitrary. As shown in FIGS. 6 to 8, the filter arrangement 29 can have two centrifugal separators 1. The cores 18 of the centrifugal separators 1 are arranged spaced apart from one another at a distance h6. The center axes 7 are preferably arranged spaced apart from one another at the distance h6 and are positioned parallel to one another.

Furthermore, the filter arrangement 29 has a holding device 30 for holding the centrifugal separators 1. The holding device 30 can be a holding plate. The holding device 30 further comprises, for example, a housing 31 in which the centrifugal separators 1 are accommodated. Fastening means 32 to 35 can be provided on the housing 31. The fastening means 32 to 35 are fastening lugs, for example. Each of the fastening means 32 to 35 can have a through hole by means of which the filter arrangement 29 can be screwed to a vehicle, for example.

As shown in FIGS. 6 and 7, the holding device 30 comprises a flange 36 extending laterally out of the housing 31, the flange having a particle discharge window or a particle discharge opening 37 that is in fluidic connection with the particle discharge openings 11 (FIG. 8) of the centrifugal separators 1.

As shown in FIG. 8, the immersion tube plate 17 of the immersion tube 9 is arranged flush with a cover plate 38 of the housing 31. A sealing device, for example in the form of an O-ring, can be provided between the cover plate 38 and the immersion tube plate 17. The immersion tube 9 can be trumpet-shaped. The immersion tube 9 has a wall thickness b. The wall thickness b is one millimeter, for example. The housing section 13 is conically shaped and widens towards the outflow opening 5, for example. As an alternative, the housing section 13 can narrow towards the outflow opening 5. The housing section 13 preferably widens or narrows at an angle γ. The housing section 13 can be conically-shaped, at least in sections. In the sectional view of the second housing section 13, the angle γ is the angle between the side walls of the housing section 13.

A circumferentially extending flange 39 is provided on the housing 3, in particular on the housing 12 of the guide apparatus 8. This flange 39 rests against a connection plate 40 of the housing 31. An O-ring can be provided between the connection plate 40 and the flange 39.

The centrifugal separator 1 has an improved separation capacity with respect to known centrifugal separators. This is achieved by a special guide apparatus design with the variable cross-sectional area A.

1. A centrifugal separator for separating particles (2) from a fluid, comprising
a guide apparatus that has a housing with an inflow opening and an outflow opening spaced apart along an axis;
a core arranged in an interior of the housing;
guide blades that are arranged in the housing and extend radially outwardly from the core to the housing;
wherein the cross-sectional area of the interior of the guide apparatus, through which the fluid flows through the guide apparatus, changes starting from the inflow opening towards the outflow opening in a flow direction of the guide apparatus.

2. The centrifugal separator according to claim 1, wherein
the cross-sectional area is defined by an annular geometry which is delimited by a radially outer surface of the core and a radially inner surface of the housing.

3. The centrifugal separator according to claim 1, wherein
the housing, the core and the guide blades are integrally monolythically formed together, in one piece, from the same material.

4. The centrifugal separator according to claim 1, wherein
the cross-sectional area decreases in the flow direction from the inflow opening to the outflow opening.

5. The centrifugal separator according to claim 1, wherein
the core has an axially extending cavity within, the cavity having an opening that opens to an exterior of the core, the opening directed towards the outflow opening.

6. The centrifugal separator according to claim 1, wherein
a respective trailing edge of the guide blades is formed to be flush with an axial end face of the core.

7. The centrifugal separator according to claim 2, wherein
a diameter of the radially outer surface of the core widens in the flow direction from the inflow opening towards the outflow opening.

8. The centrifugal separator according to claim 7, wherein
the core is conically shaped at least in sections; and
wherein a cone angle of the radially outer surface of the core is approximately 3 degrees.

9. The centrifugal separator according to claim 1, wherein
the housing narrows in the flow direction.

10. The centrifugal separator according to claim 1, wherein
at least one guide blade of the guide blades of the guide apparatus extends over more than a full helical winding around the core.

11. The centrifugal separator according to claim 1, wherein
the guide blades exhibit a multiple overlapping;
wherein the multiple overlapping is at least a 2, 3, 4 or 5-fold overlapping.

12. A filter arrangement comprising
at least one centrifugal separator, including
a guide apparatus that has a housing with an inflow opening and an outflow opening spaced apart along an axis;
a core arranged in an interior of the housing;
guide blades that are arranged in the housing and extend radially outwardly from the core to the housing;
wherein the cross-sectional area of the interior of the guide apparatus, through which the fluid flows through the guide apparatus, changes starting from the inflow opening towards the outflow opening in a flow direction of the guide apparatus; and
a holding device configured to hold or mount the at least one centrifugal separator therein.
